(19) United States
(12) Patent Application Publication
(10) Pub. No.: US 2007/0177585 A1
(43) Pub. Date: Aug. 2, 2007

(54) RADIO COMMUNICATION DEVICE WITH ACCESS MEANS CONFORMING TO THE GAN AND 3GPP-WLAN INTERWORKING TECHNOLOGIES, AND CORRESPONDING ACCESS NETWORK CONTROLLER

(75) Inventors: Yacine El Mghazli, Arcueil (FR); Lionel Fiat, Garches (FR); Eric Desorbay, Campbon (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/670,415

(22) Filed: Feb. 1, 2007

(30) Foreign Application Priority Data
Feb. 2, 2006 (FR) 0650379

(51) Int. Cl. H04L 12/66

(52) U.S. Cl. 370/352

(57) ABSTRACT

The invention concerns a radio communication device (700) comprising:
for circuit-switched services, first access means, enabling access to a mobile network via a first access network included in a wireless local area network,
for packet-switched services, second access means (70), enabling access to the mobile network via the first access network.

According to the invention, the first access means conform to the “GAN” technology and the second access means conform to the “3GPP-WLAN Interworking” technology. The technologies are defined in the 3GPP standards.

### CROSS-REFERENCE TO RELATED APPLICATIONS

This application is based on French Patent Application No. 0650379 filed Feb. 2, 2006, the disclosure of which is hereby incorporated by reference thereto in its entirety, and the priority of which is hereby claimed under 35 U.S.C. §119.

### BACKGROUND OF THE INVENTION

1. Field of the Invention

The field of the invention is that of interworking between networks, and more precisely (2G/3G)/WLAN interworking, that is to say interworking between at least one wireless local area network (WLAN) and one 2G/3G mobile network.

By 2G/3G mobile network is meant a 2nd and 3ed generation mobile network, such as for example a GSM/GPRS (“Global System for Mobile Communication/General Packet Radio Service”) network, a UMTS (“Universal Mobile Telecommunication System”) network, a CDMA2000 (“Code Division Multiple Access 2000”) network, etc.

Such (2G/3G)/WLAN interworking aims to enable wireless IP (“Internet Protocol”) access technologies (for example conforming to the WiFi or WiMAX standard) to work with 2G/3G mobile network core infrastructures, in order to enable a WLAN user to access circuit-switched (CS) services and packet-switched (PS) services via IP wireless access networks.

The technical problem to be solved is the management of access to the circuit-switched and packet-switched services. More precisely, it is a question of enabling a WLAN user to access, by means of a radio communication terminal (also called radio communication device hereinafter) (for example, a mobile telephone, a PDA (“Personal Digital Assistant”), or a portable computer), on the one hand high bit rate packet-switched services (for example multimedia services of the IMS (“IP Multimedia Subsystem”) type with heterogeneous wireless access) and on the other hand circuit-switched services (for example voice transport services).

2. Description of the Prior Art

The 3GPP (“3ed Generation Partnership Project”) standards define a plurality of technologies for access to a 3G mobile network via an IP access network.

The drawbacks of the prior art are discussed hereinafter through specific cases of “GAN” (standing for “Generic Access Network”) access technologies (generally called “UMA” standing for “Unlicensed Mobile Access”) and “3GPP-WLAN Interworking” (denoted “I-WLAN” in the remainder of this document).

There will now be described with reference to FIGS. 1 to 3 the architectures of a network 100 and a radio communication terminal 200 (also called a mobile station hereinafter, “MS” standing for “Mobile Station”) conforming to the “GAN” technology.

As shown in FIG. 1, the “GAN” technology enables a mobile station (MS) 200:

to access one or more 3GPP circuit-switched services (“3GPP CS services”) offered by a core network CN (2G/3G core network):
via a core network controller MSC (standing for “Mobile Switching Center”) connected to a radio network controller BSC/RNC (“Base Station Controller/Radio Network Controller”), belonging to an access network of GERAN/UTRAN type (standing for “GSM Edge Radio Access Network/UMTS Terrestrial Radio Access Network”). As shown in FIG. 2, the mobile station (MS) 200 includes access means 10 to the circuit-switched services via the GERAN-UTRAN network (see paragraph 6.1.1.2 of the 3GPP standardization documentation TS 43.318 for a detailed description of these access means). Referring to FIG. 1, the mobile station (MS) 200 is connected to a base station BTS/Node B (BTS standing for “Base Transceiver Station”), via an interface Um/Uu. The base station BTS/Node B is connected to the radio network controller BSC/RNC, via an interface Abis/lub. The radio network controller BSC/RNC is connected to the core network controller MSC via an interface A/lu-Cs; or
   via the core network controller MSC connected to a generic access network controller GANC (standing for “GAN Controller”), belonging to an IP type access network (for example of the Internet type). As shown in FIG. 2, the mobile station (MS) 200 includes access means 20 to the circuit-switched services via the IP access network (see paragraph 6.1.1.2 of the 3GPP standardization document TS 43.318 for a detailed description of these access means). Referring to FIG. 1, the mobile station (MS) 200 communicates, via a radio relay 300, with the access network controller GANC, via an interface Up. The access network controller GANC is connected to the core network controller MSC, via an interface A;

to access one or more 3GPP packet-switched services (“3GPP PS services”) offered by the core network CN:
via a node SGSN (standing for “Serving GPRS Support Node”) connected to the radio network controller BSC/RNC, belonging to the access network GERAN/UTRAN. As shown in FIG. 3, the mobile station (MS) 200 includes access means 30 to the packet-switched services via the network GERAN/UTRAN (see paragraph 6.2.2 of the 3GPP standardization document TS 43.318 for a detailed description of these access means). Referring to FIG. 1, the mobile station (MS) 200 is connected to the base station BTS/Node B, via the interface Um/Uu. The base station BTS/Node B is connected to the radio network controller BSC/RNC, via the interface Abis/lub. The radio network controller BSC/RNC is connected to the node SGSN, via an interface Gb/lu-Ps; or
   via the node SGSN connected to the access network controller GANC, belonging to the IP access network. As shown in FIG. 3, the mobile station (MS) 200 includes access means 40 to the packet-switched services via the IP access network (see paragraph 6.2.2 of the 3GPP standardization document TS 43.318 for a detailed description of these access means). Referring to FIG. 1, the mobile station (MS) 200 communicates, via the radio relay 300, with the access network controller GANC, via the interface Up. The access network controller GANC is connected to the node SGSN via an interface Gb.

The advantage of the “GAN” technology is that it enables continuity of service to be maintained across the WLAN and 2G/3G radio access networks for the services transporting voice and low bit rate data.

However, for the services transporting high bit rate data, it has a certain number of drawbacks. In fact, the efficacy of this technology is limited by the fact that the node SGSN, which is connected to the access network GANC via the interface Gb, cannot transfer (“handover”) a real time (voice type) call in progress from a WLAN network to a 2G/3G network without interrupting the call.

There are described now with reference to FIGS. 4 and 5 the architectures of a network 400 and a mobile station 500 conforming to the “I-WLAN” technology.

As shown in FIG. 4, the “I-WLAN” technology enables a mobile station (MS) 500 to access one or more 3GPP packet-switched services (“3GPP PS services”) offered by a core network CN (2G/3G core network):

via a node SGSN (standing for “Serving GPRS Support Node”) connected to a radio network controller BSC/RNC, belonging to an access network GERAN/UTRAN. As shown in FIG. 5, the mobile station (MS) 500 includes access means 50 to the packet-switched services via the network GERAN/UTRAN (see the 3GPP standardization document TS 23.060). Referring to FIG. 4, the mobile 5 station (MS) 500 is connected to a base station BTS/Node B, via an interface Um/Uu. The base station BTS/Node B is connected to the radio network controller BSC/RNC, via an interface Abis/lub. The radio network controller BSC/RNC is connected to the node SGSN, via an interface Gb/lu-Ps; or
via a node GGSN (standing for “Gateway GPRS Support Node”) connected to a gateway TTG (standing for “Tunnel Termination Gateway”), the node GGSN and the gateway TTG both belonging to the core network CN. As shown in FIG. 5, the mobile station (MS) 500 includes access means 60 to the packet-switched services via the gateway TTG of the core network CN (see paragraph 6.2.1 of the 3GPP standardization document TS 23.234). Referring to FIG. 4, the mobile station (MS) 500 communicates, through the intermediate of a radio relay 600, with the gateway TTG, via an interface Wu. The gateway TTG is connected to the node GGSN, via an interface Gn′/Gn.

Although the “I-WLAN” technology represented a major advance in the mechanism of access to high bit rate packet-switched services, this technology nevertheless has the disadvantages of not enabling a WLAN user to access circuit-switched services and of not maintaining continuity of services across the WLAN and 2G/3G radio access network.

There is therefore a need to optimize the architectures for access to the circuit-switched and packet-switched services, as much on the mobile station side 25 as on the network side, particularly to enable a WLAN user to move from an IP access network to a 2G/3G mobile network, and vice-versa, whilst maintaining continuity of service, regardless of the type of service access.

### SUMMARY OF THE INVENTION

Among others, the invention has the objective of alleviating these drawbacks of the prior art.

More precisely, one of the objectives of the present invention, in at least one embodiment, is to provide an access technique to the 3GPP services that is simple to use and efficacious, among other things in terms of speed of access, i.e. that enables an exchange of data at high bit rate between a mobile station and a 3G core network.

Another objective of the invention is to provide such an access technique which, in at least one embodiment, is particularly well adapted to the 3GPP packet-switched services.

Another objective of the invention is to provide such an access technique which, in at least one embodiment, is particularly well adapted to the 3GPP circuit-switched services.

A further objective of the invention is to provide such an access technique which, in one particular embodiment, is particularly well adapted to all existing 2G/3G networks.

A complementary objective of the invention, in at least one embodiment, is to provide such an access technique that does not lead to costly or complex modification of current mobile stations and access networks.

These objectives, together with others that will become apparent hereinafter, are achieved with the aid of a radio communication device comprising:

for circuit-switched services, first access means, enabling access to a mobile network via a first access network included in a wireless local area network,

for packet-switched services, second access means, enabling access to said mobile network via said first access network.

According to the invention the first access means conform to the “GAN” technology and the second access means conform to the “3GPP-WLAN Interworking” technology. The technologies are defined in the 3GPP standards.

Thus the invention is based on an entirely novel and inventive approach to access from a mobile station (also called radio communication device) to the 3GPP services of a 2G/3G core network. In fact, the invention proposes to implement in the same mobile station access means according to the “GAN” (that is to say “UMA-CS”) and “I-WLAN” (that is to say “3GPP-WLAN Interworking”) technologies, enabling access to circuit-switched and packet-switched services, respectively.

In other words, the invention proposes a hybrid technology that combines management of continuity of service for the circuit-switched services conforming to the “GAN” technology with management of access to high bit rate packet-switched services conforming to the “I-WLAN” technology.

The present invention also covers the case of a mobile station, in which an extended “GAN” technology (“UMA extended solution”) is implemented (in place of the standard “GAN” technology), using interfaces of type lu-CS/lu-PS (in place of the interfaces A/Gb of the standard “GAN” technology).

According to one advantageous aspect of the invention, the device further comprises:

for said circuit-switched services, third access means, enabling access to said mobile network via a second access network included in said mobile network; and

for said packet-switched services, fourth access means, enabling access to said mobile network via said second access network included in said mobile network.

The third access means conform to the “GAN” technology and the fourth access means conform to the “3GPP-WLAN Interworking” technology.

In a preferred embodiment of the invention the device further comprises, for said packet-switched services, distribution means for assigning PDP streams to said second access means or said fourth access means.

Said second access means advantageously comprise control means for:

managing the establishment of an IPsec tunnel for each PDP stream; and

matching each PDP stream with an IPsec tunnel.

The invention also concerns an access network controller, enabling a radio communication device:

for circuit-switched services, to access a mobile network via a first access network included in a wireless local area network,

for packet-switched services, to access said mobile network via said first access network.

According to the invention, said access network controller comprises:

a unit GANC-CS that corresponds to the part relating to the circuit-switched services of a controller GANC conforming to the “GAN” technology, for managing the streams for the circuit-switched services;

a gateway TTG conforming to the “3GPP-WLAN Interworking” technology, for managing streams for the packet-switched services, said technologies being defined in the 3GPP standards; and

distribution means for assigning each stream to said unit GANC-CS or said gateway TTG.

Thus the invention is based on the use of a hybrid wireless IP network controller (Hybrid-WNC), in which are implemented an access network controller GANC-CS enabling a mobile station to access circuit-switched services and a gateway TTG enabling the mobile station to access packet-switched services.

It is to be noted that the invention advantageously enables re-use of the existing infrastructures of the 2G/3G core network, including, although not exclusively, a core network controller MSC, a node GGSN, etc.

Moreover, it is important to note that additional functions may be implemented by the gateway TTG, including, although not exclusively, functions that offer mobility between the 2G/3G radio network and the WLAN network.

The access network controller advantageously further comprises a single security gateway SEGW placed on the upstream side of said unit GANC-CS and said gateway TTG, on the same side as the radio communication device.

Said security gateway SEGW preferably comprises said distribution means.

### BRIEF DESCRIPTION OF THE DRAWINGS

Other features and advantages of the invention will become more clearly apparent on reading the following description of a preferred embodiment, given by way of illustrative and nonlimiting example only, and from the appended drawings, in which:

FIGS. 1 to 5, already commented on in relation to the prior art, show:

FIG. 1: the architecture of a communication network conforming to the “GAN” technology;

FIG. 2: the architecture of a mobile station conforming to the “GAN” technology, for circuit-switched services;

FIG. 3: the architecture of the mobile station from FIG. 2, for packet-switched services;

FIG. 4: the architecture of a communication network conforming to the “I-WLAN” technology;

FIG. 5: the architecture of a mobile station conforming to the “I-WLAN” technology, for packet-switched services;

FIG. 6 shows the diagram of a radio communication device according to a preferred embodiment of the invention, for packet-switched services;

FIG. 7 shows the diagram of one particular embodiment of an access network controller according to the invention, for access to packet-switched services; and

FIG. 8 shows one example of a diagram of the exchange of messages between different entities of the network, in the case of access to the packet-switched services shown in FIG. 7.

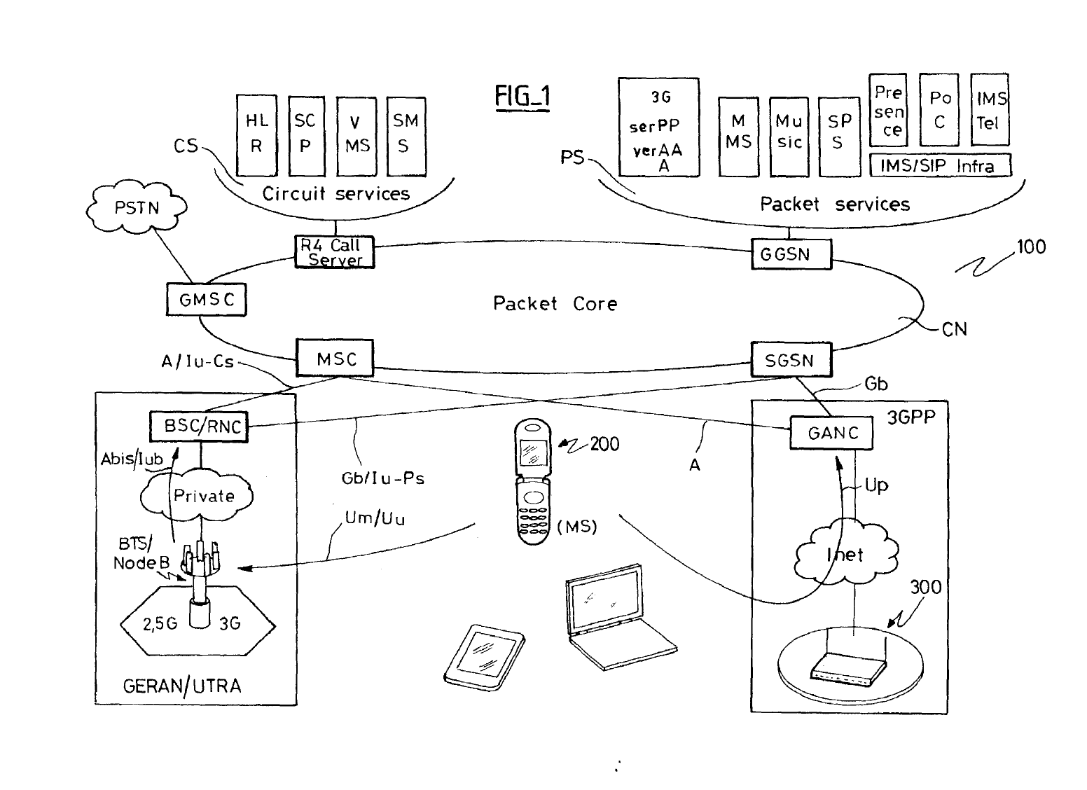

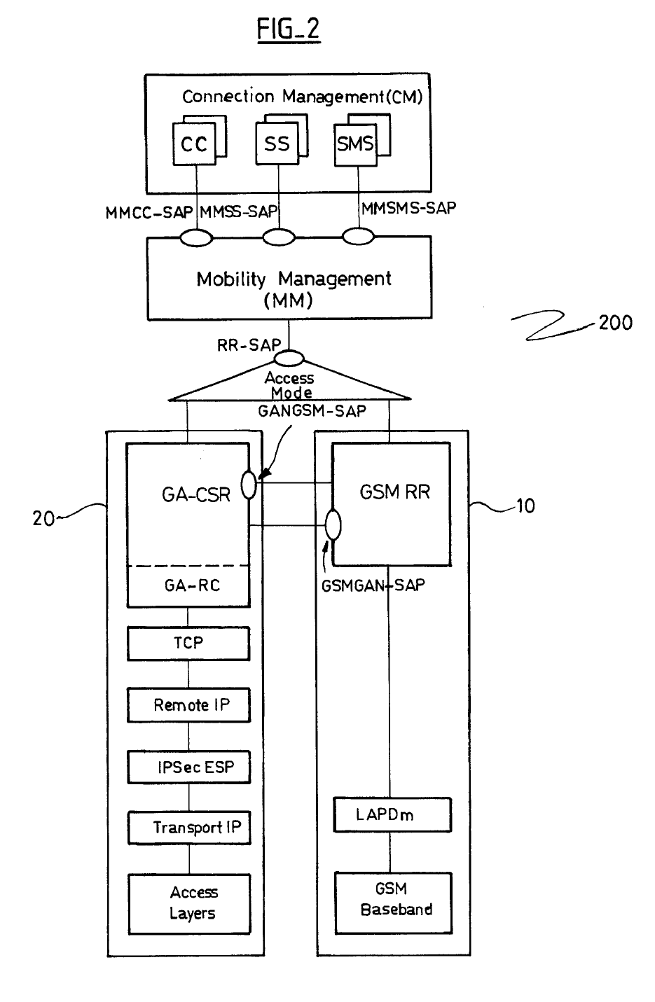

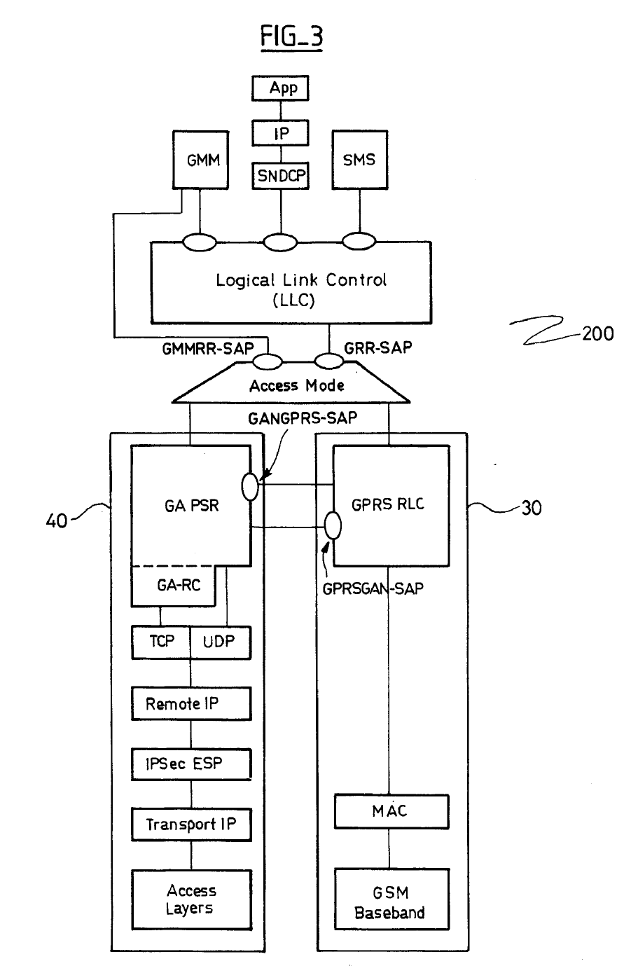

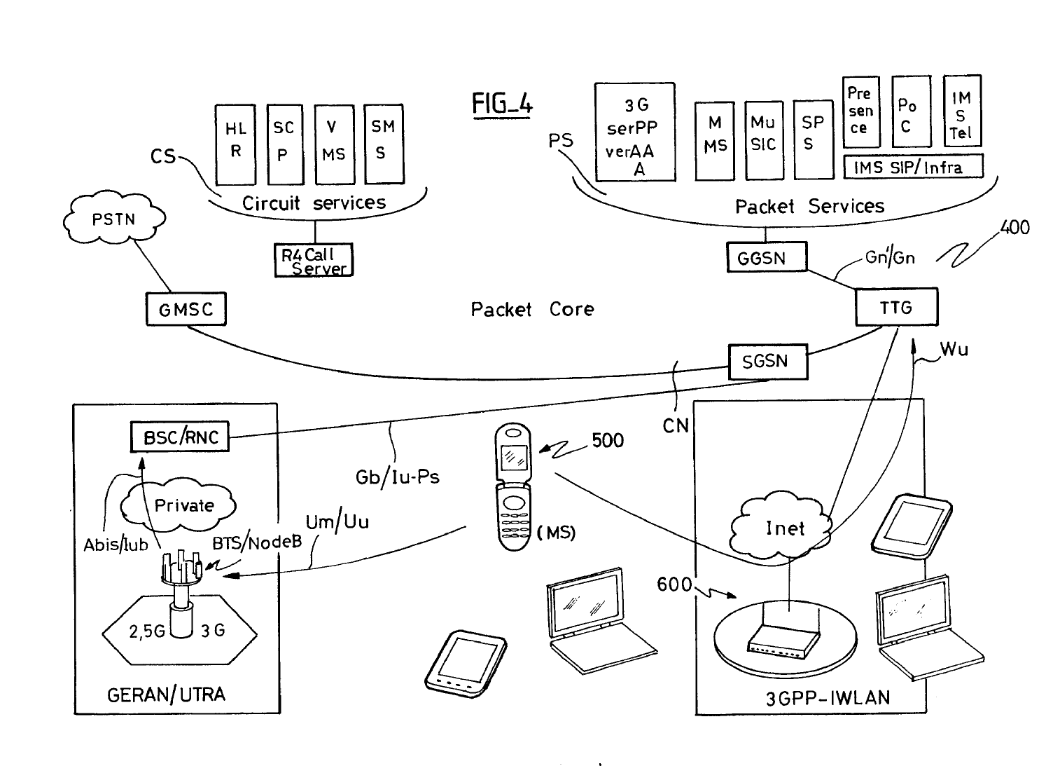

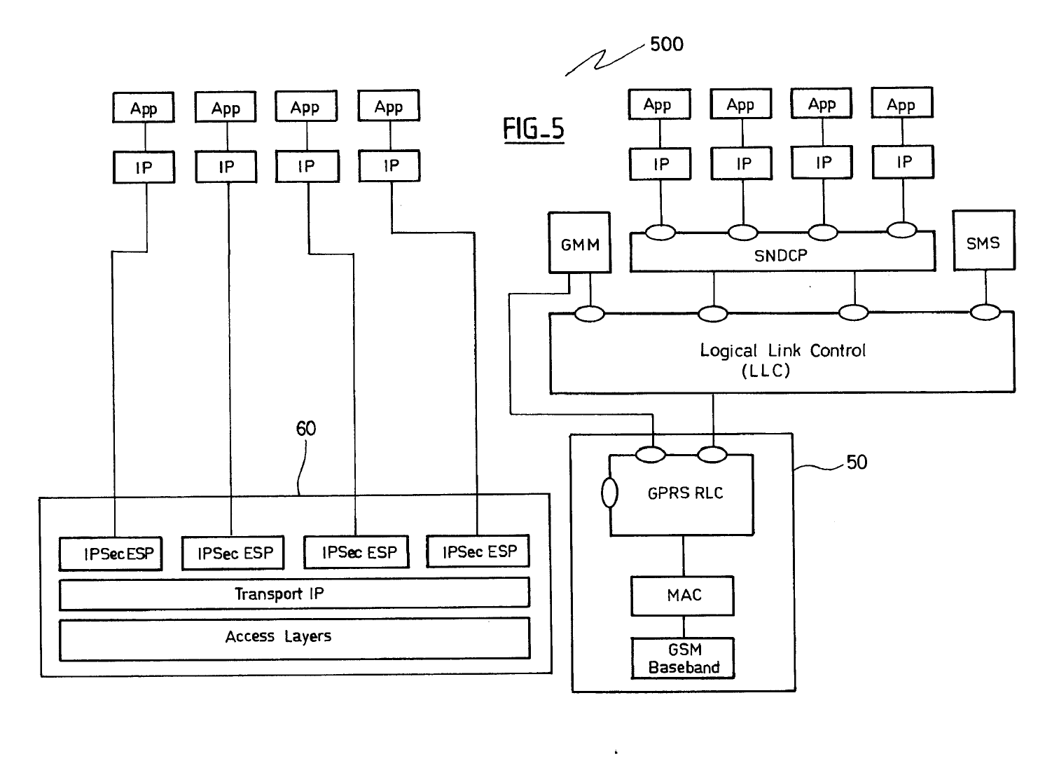

### DETAILED DESCRIPTION OF A PREFERRED EMBODIMENT

To simplify the description, the remainder of this document will be limited to describing the access means to the packet-switched services of a radio communication device operating in accordance with the “GAN” and “I-WLAN” technologies. The circuit-switched service access means of such a device are described in detail in the 3GPP standardization document TS 43.318.

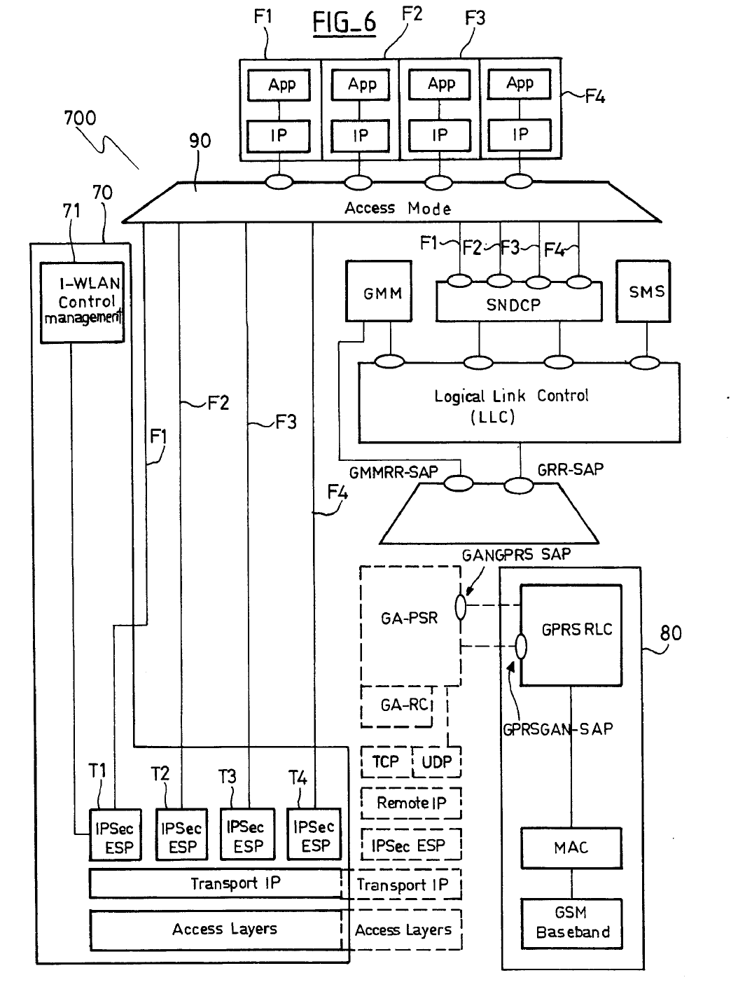

FIG. 6 shows diagrammatically one particular embodiment of a radio communication device 700 (also called a mobile station hereinafter) according to the invention, enabling implementation of the “I-WLAN” technology for access to packet-switched services via access networks of GERAN/UTRAN and IP type.

In this embodiment, the mobile station 700 according to the invention includes, for packet-switched services:

PDP (“Packet Data Protocol”) stream distribution means 90 specific to the invention;

first access means 70 specific to the invention, which conform to the “I-WLAN” technology and which enable access to a 2G/3G mobile network via an IP access network; and

second access means 80 of a standard type in themselves, which conform to the “I-WLAN” technology and which enable access to the 2G/3G mobile network via a GERAN/UTRAN access network.

The remainder of this document describes the particular case of a mobile station operating with four PDP streams. The man skilled in the art will easily expand this teaching to a mobile station operating with a larger or smaller number of PDP streams.

The distribution means 90 receive as input PDP streams F1, F2, F3 and F4, each corresponding to an instantiation of the “App/lIP” (“Application/Internet Protocol”) layers, and at the output direct each PDP stream to the first access means 70 or the second access means 80 to the 2G/3G mobile network. In other words, the distribution means 90 manage the matching (“mapping”) of the data traffic (PDP streams) according to the radio access used, so that:

if the radio access used is a WLAN radio access, for example of the WiFi type, then the PDP streams are assigned to the first access means 70;

on the other hand, if the radio access used is a 2G/3G radio access, for example of the GSM type, then the PDP streams are assigned to the second access means 80.

As will emerge in the remainder of the description, if the PDP streams are transmitted/received via the WLAN radio access, each PDP stream is associated with an Ipsec tunnel.

In the embodiment shown, the first access means 70 include control means 71 for managing the setting up of an Ipsec tunnel T1, T2, T3 and T4 for each PDP stream F1, F2, F3 and F4 and for matching each PDP stream with an Ipsec tunnel.

Accordingly, the mobile station 700 of the invention is particularly well adapted to a packet-switched service with multiple radio access and enables a WLAN user to access 3GPP services of a 2G/3G mobile network using the best available connection.

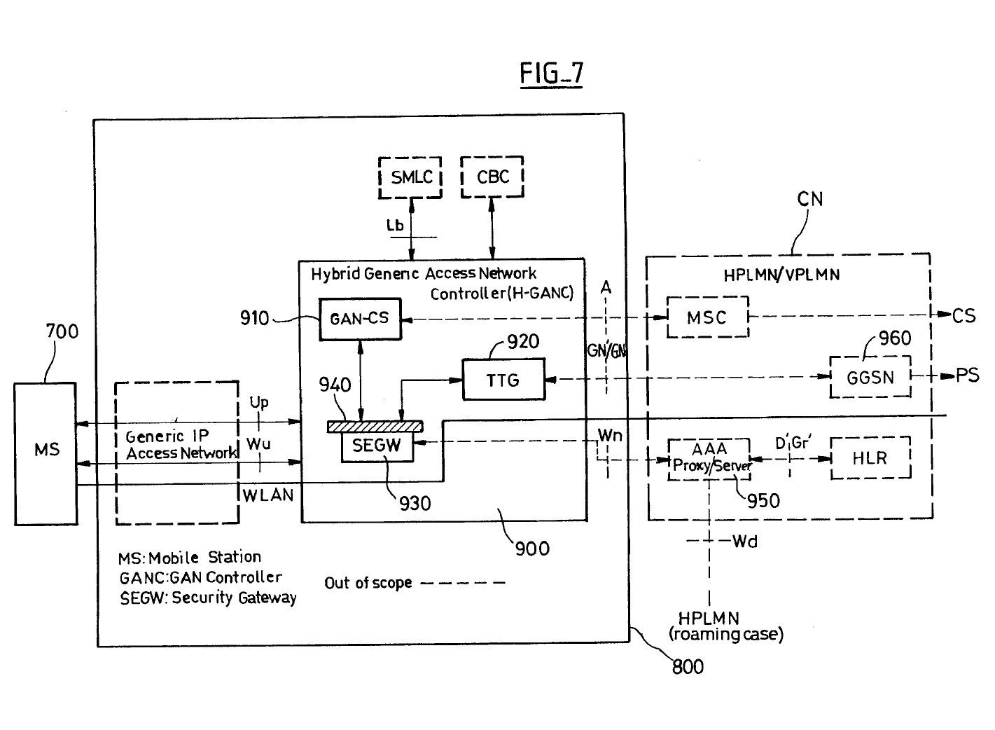

There is described now with reference to FIG. 7, an IP access network 800 using an access network controller 900 according to a preferred embodiment of the invention.

In the present embodiment, the access network controller 900 includes:

a module GANC-CS (910) that corresponds to the part relating to the circuit-switched services of a controller GANC (see paragraph 4 of the 3GPP standardization document TS 43.318) conforming to the “GAN” technology. This module GANC-CS (910) enables management of streams for the circuit-switched services;

a gateway TTG (920) (see appendix F of the 3GPP standardization document TS 23.234) conforming to the “I-WLAN” technology, enabling management of the streams for the packet-switched services; and

a security gateway SEGW (930) placed on the upstream side of the module GANC-CS (910) and the gateway TTG (920), on the same side as the mobile station 700.

In this embodiment, the security gateway SEGW (930) includes distribution means 940 for assigning each PDP stream to the module GANC-CS (910) or to the gateway TTG (920).

As shown in FIG. 7, for packet-switched services, the mobile station 700 (which uses the first access means 70 cited above) communicates with the security gateway SEGW (930), via an interface Wu. The security gateway SEGW (930) transmits/receives streams of data via the gateway TTG (920). The gateway TTG (920) is connected to a node GGSN (960) via an interface Gn′/Gn.

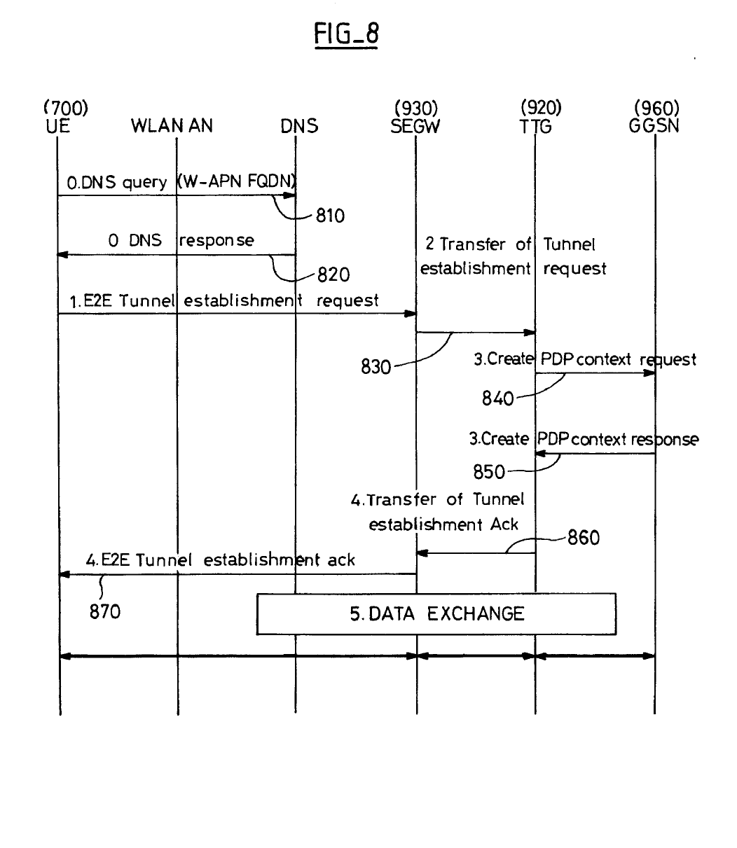

There is described now, with reference to FIG. 8, one example of a diagram of the exchange of messages between different entities of the network to effect access to the packet-switched services shown in FIG. 7.

The entities concerned, which have already been described hereinabove, are as follows: the mobile station 700, the network WLAN, the security gateway SEGW (930), the gateway TTG (920) and the node GGSN (960).

It is assumed that the mobile station 700 has authenticated itself beforehand to an AAA (“Authentication, Authorization & Accounting”) server 950 (see FIG. 7) in the core network CN.

Initially, the mobile station 700 sets up a connection with the network WLAN.

The mobile station 700 then submits 810 a DNS (standing for “Domain Name System”) request, in order to retrieve the IP address of the security gateway SEGW (930).

After it has obtained the IP address of the security gateway SEGW (930), the mobile station 700 sends 820 an end to end tunnel establishment request (E2E Tunnel Establishment Request) to the security gateway SEGW (930).

After receiving the request 820 cited above, the security gateway SEGW (930) transfers 830 the receive request to the gateway TTG (920).

The gateway TTG (920) then sends 840 the node GGSN (960) a request for creation of context information relating to the communication session (Create PDP Context Request).

The node GGSN (960) creates 850 the context information cited above and returns a context information creation confirmation (Create PDP Context Response).

The gateway TTG (920) transfers 860 the confirmation cited above to the security gateway SEGW (930).

Finally, the security gateway SEGW (930) sends 870 the mobile station 700 a message accepting the establishing of an end to end tunnel (E2E Tunnel Establishment Ack).

1. Radio communication device (700) comprising:
for circuit-switched services, first access means, enabling access to a mobile network via a first access network included in a wireless local area network, for packet-switched services, second access means (70), enabling access to said mobile network via said first access network, characterized in that said first access means conform to the “GAN” technology and said second access means conform to the “3GPP-WLAN Interworking” technology, said technologies being defined in the 3GPP standards.

2. Device (700) according to claim 1, characterized in that it further comprises:
for said circuit-switched services, third access means, enabling access to said mobile network via a second access network included in said mobile network; and
for said packet-switched services, fourth access means (80), enabling access to said mobile network via said second access network included in said mobile network;
and in that said third access means conform to the “GAN” technology and said fourth access means conform to the “3GPP-WLAN Interworking” technology.

3. Device (700) according to claim 2, characterized in that it further comprises, for said packet-switched services, distribution means (90) for assigning PDP streams (F1 to F4) to said second access means (70) or said fourth access means (80).

4. Device (700) according to claim 1, characterized in that said second access means (70) comprise control means (71) for:
managing the establishment of an IPsec tunnel (T1 to T4) for each PDP stream (F1 to F4); and
matching each PDP stream with an IPsec tunnel.

5. Access network controller (900), enabling a radio communication device (700):
for circuit-switched services, to access a mobile network via a first access network included in a wireless local area network,
for packet-switched services, to access said mobile network via said first access network,
characterized in that said access network controller (900) comprises:
a unit GANC-CS (910) that corresponds to the part relating to the circuit-switched services of a controller GANC conforming to the “GAN” technology, for managing the streams for the circuit-switched services;
a gateway TTG (920) conforming to the “3GPP-WLAN Interworking” technology, for managing streams for the packet-switched services, said technologies being defined in the 3GPP standards; and
distribution means (940) for assigning each stream to said unit GANC-CS or said gateway TTG.

6. Access network controller (900) according to claim 5, characterized in that it further comprises a single security gateway SEGW (930) placed on the upstream side of said unit GANC-CS (910) and said gateway TTG (920), on the same side as the radio communication device (700).

7. Access network controller (900) according to claim 6, characterized in that said security gateway SEGW (930) comprises said distribution means (940).
